(19) United States
(12) Patent Application Publication
(10) Pub. No.: US 2012/0186756 A1
(43) Pub. Date: Jul. 26, 2012

(54) SUNSHADE DEVICE FOR A REAR WINDOW OF A VEHICLE

(75) Inventor: Paul Lin, Tainan City (TW)

(73) Assignee: MACAUTO INDUSTRIAL CO., LTD., Tainan City (TW)

(21) Appl. No.: 13/012,530

(22) Filed: Jan. 24, 2011

(51) Int. Cl. B60J 3/02

(52) U.S. Cl. 160/323.1

(57) ABSTRACT

A sunshade device includes a winding shaft, two track rails, a sunshade cloth with two ends respectively connected to a cross bar and a winding shaft, two end piece units connected respectively to two opposite ends of the cross bar and each having a headed pivot, and two sliding units each having a pivot plate pivotally and detachably attached to one of the end piece units through the headed pivot. Because the pivot plate can be easily and quickly attached to or detached from the headed pivot, assembly or disassembly of the sunshade device of the present invention is convenient.

### 1. FIELD OF THE INVENTION

The invention relates to a sunshade device for a vehicle, more particularly to a sunshade device mountable on a rear window of a vehicle and operable automatically to stretch and retract a sunshade cloth.

### 2. DESCRIPTION OF THE RELATED ART

FIG. 1 shows a conventional sunshade device 1 for a rear window of a vehicle disclosed in U.S. Pat. No. 7,188,659. The sunshade device 1 includes a self-rotatable winding shaft 11 installed horizontally below a rear window shelf (not shown) disposed behind rear vehicle seats of the vehicle, a pair of track rails 12, which are respectively mounted on inner sides of a pair of C columns of the vehicle (not shown) and extends from the rear window shelf to a top edge of the rear window, a cross bar 13 parallel to and disposed substantially above the winding shaft 11 and movable between the top edge of the rear window and the rear window shelf, a pair of end piece units 14 connected respectively to two opposite ends of the cross bar 13, a pair of slides 15 connected respectively to the end piece units 14 and mounted slidably on the respective track rails 12, a pair of driving rods 16 mounted slidably and respectively inside the track rails 12 for driving the respective slides 15, a power element 17 for operating the driving rods 16, and a sunshade cloth 18 that has top and bottom ends respectively connected to the cross bar 13 and the winding shaft 11.

When the power element 17 drives the driving rods 16 to move upward, the driving rods 16 push the slides 15 upward, which in turn move the cross bar 13 toward the top edge of the rear window, expanding the sunshade cloth 18. During the upward movement, as the distance between the track rails 12 decreases, the end piece units 14 are retracted into the cross bar 13. When the power element 17 drives the driving rods 16 to move downward, the driving rods 16 pull the slides 15 downward, and the winding shaft 11 rewinds the sunshade cloth 18 and causes the cross bar 13 to move downward. Because the distance between the lower parts of the track rails 12 is enlarged, the end piece units 14 project outward from the cross bar 13 when the cross bar 13 moves downward.

Since the distance between the track rails 12 changes during the expanding and retracting operations of the sunshade cloth 18, the connecting structure between the end piece units 14 and the slides 15 has to be carefully and rather precisely designed and implemented so as to ensure smooth movement of the cross bar 13 and hence the smooth expanding and collapsing operations of the sunshade cloth 18. Moreover, the convenience of assembly and disassembly among the cross bar 13, the end piece units 14 and the slides 15 of this conventional sunshade device 1 still has room for improvement.

### SUMMARY OF THE INVENTION

A main object of the present invention is to provide a sunshade device for a rear window of a vehicle that can be easily assembled and disassembled.

Accordingly, a sunshade device for a rear window of a vehicle of the present invention comprises: a winding shaft, two track rails, a cross bar substantially parallel to the winding shaft, a sunshade cloth having top and bottom ends respectively connected to the cross bar and the winding shaft, two end piece units connected respectively to two opposite ends of the cross bar, and two sliding units connected respectively to the end piece units and mounted slidably and respectively on the track rails. Each of the end piece units includes an end piece inserted telescopically into one of the opposite ends of the cross bar, and a headed pivot projecting from the end piece and disposed outwardly of the cross bar. The headed pivot has a pivot pin, a head plate connected to the pivot pin, and a groove formed between the head plate and the end piece. Each of the sliding units includes a slide disposed slidably inside one of the track rails, and a pivot plate connected to the slide, disposed outwardly of the track rail, and disposed detachably around the pivot pin and between the head plate and the end piece. The pivot plate defines a wide through hole for passage of the head plate, a narrow through hole connected to one side of the wide through hole to receive the pivot pin, and a spring plate formed in the wide through hole and having a free end to abut against the head plate when the pivot pin is received in the narrow through hole.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a conventional sunshade device for a rear window of a vehicle;

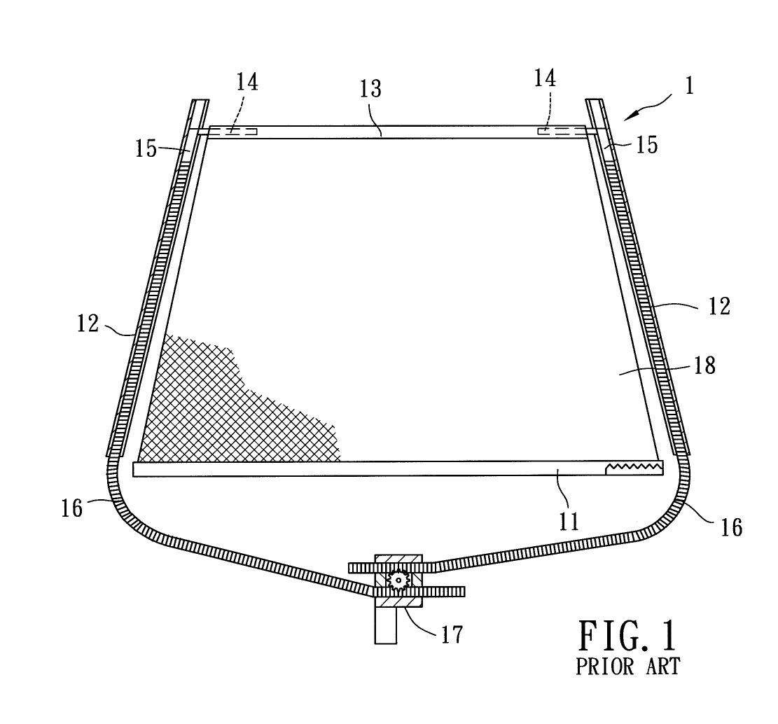

FIG. 2 is a schematic diagram illustrating the preferred embodiment of a sunshade device for a rear window of a vehicle according to the present invention;

FIG. 3 is a fragmentary enlarged view of the preferred embodiment;

FIG. 4 is a fragmentary perspective view of the preferred embodiment; and

FIG. 5 is a fragmentary sectional view of the preferred embodiment.

### DETAILED DESCRIPTION OF THE PREFERRED EMBODIMENT

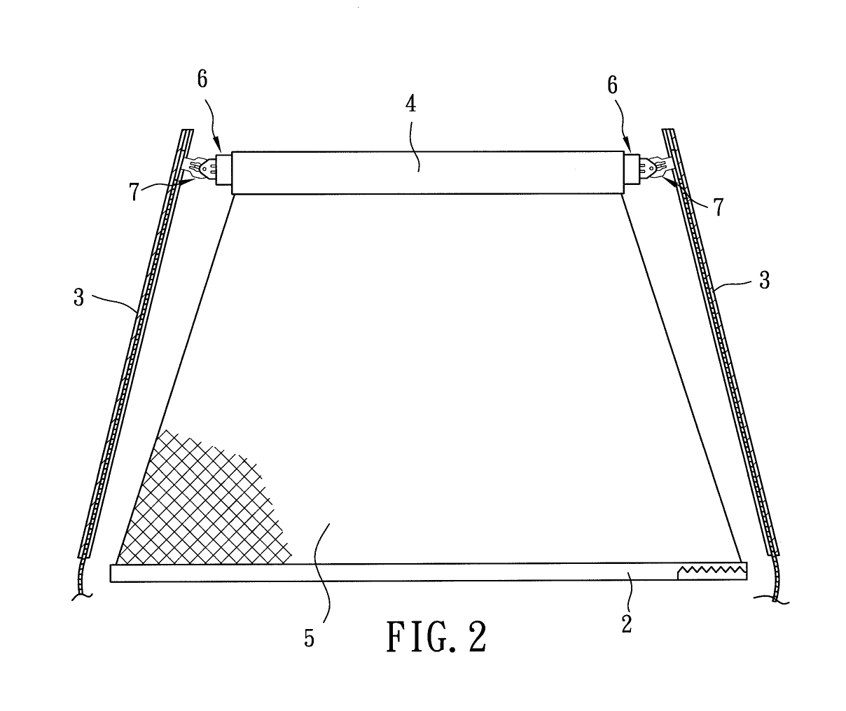

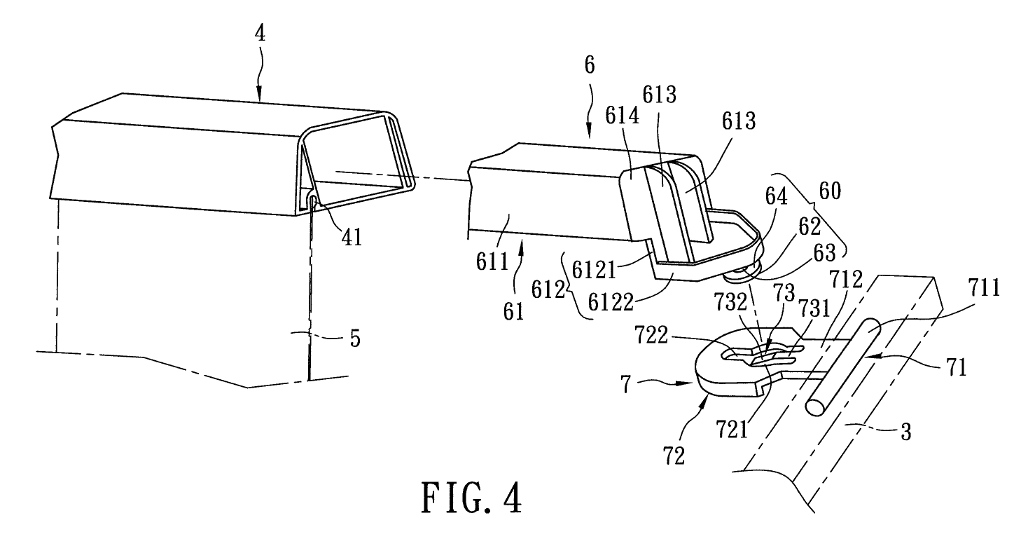

Referring to FIGS. 2 to 4, the preferred embodiment of a sunshade device according to the present invention is shown. Most of the sunshade device is mounted above or below a rear window shelf (not shown) of a vehicle, and the remaining part thereof is mounted on left and right C columns (not shown) of the vehicle.

The sunshade device includes a rotatable winding shaft 2 mounted horizontally below the rear window shelf, a pair of track rails 3 respectively mounted on inner sides of the respective C columns and extending from a top end of the rear window shelf to a top edge of the rear window (not shown in the Figure), a cross bar 4 parallel to and disposed substantially above the winding shaft 2 and movable upward and downward between a rear end of the rear window shelf and the top end of the rear window, a sunshade cloth 5 that has top and bottom ends respectively connected to the cross bar 4 and the winding shaft 2, a pair of end piece units 6 connected respectively and telescopically to two opposite ends of the cross bar 4, and a pair of sliding units 7 connected respectively to the end piece units 6 and mounted respectively on the track rails 3 to slide along a length direction of the track rails 3. In this embodiment, the cross bar 4 has a hollow structure and a generally square cross section. The sunshade cloth 5 has a top end fixed to a slot 41 formed in a front bottom side of the cross bar 4.

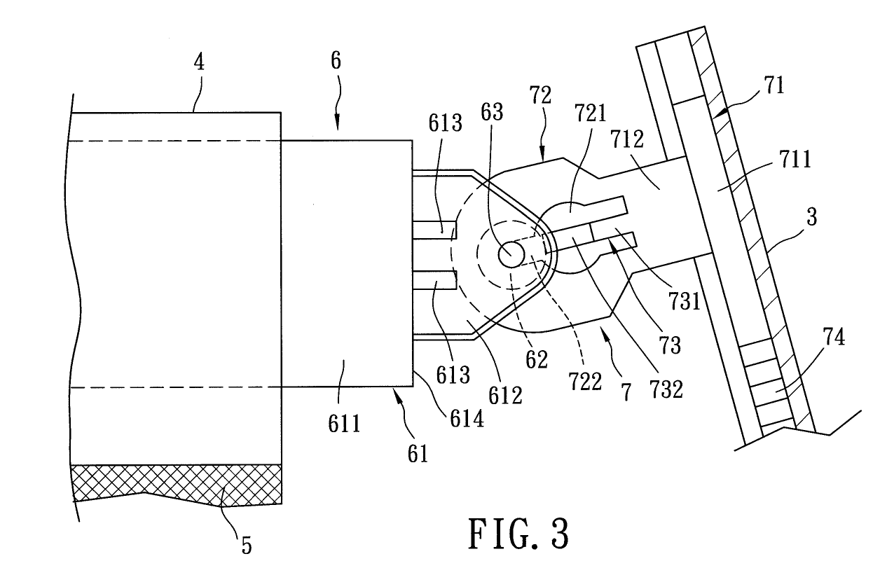

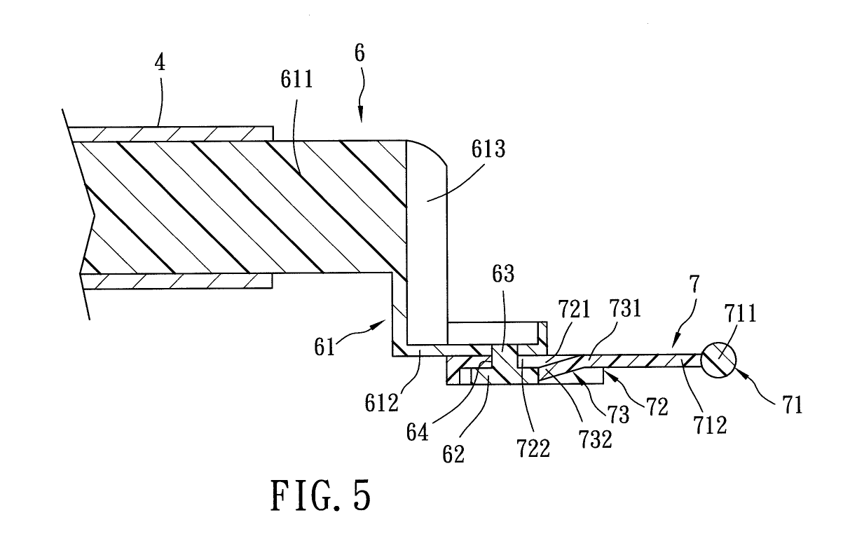

As shown in FIGS. 3 to 5, each of the end piece units 6 is connected pivotally to a corresponding one of the sliding units 7. Each of the end pieces 61 includes an insert part 611 inserted telescopically into one of the opposite ends of the cross bar 4, and a headed pivot 60 projecting from the end piece 61 and disposed outwardly of the cross bar 4. The headed pivot 60 has a pivot pin 63, a head plate 62 connected to the pivot pin 63, and a groove 64 formed between the head plate 62 and the end piece 61.

Each end piece 61 further includes an extension plate 612 projecting from an outer end of the insert part 611. The outer end of the insert part 611 has an end face 614 transverse to the cross bar 4. The extension plate 612 has a first part 6121 that projects transversely and forwardly from a front side of the outer end of the insert part 611 and that is flush with the end face 614, and a second part 6122 that is angled from the first part 6121 and that is parallel to and offset from the insert part 611. The pivot pin 63 projects from the second part 6122.

Each end piece 61 further includes upper and lower two ribs 613, each of which projects from the end face 614 and the first part 6121 and has an end fixed to one side of the second part 6122 opposite to the pivot pin 63. In this embodiment, each end piece 61 has a generally square cross section. Each rib 613 has a plate shape. Each head plate 62 is circular. Each pivot pin 63 is cylindrical and is coaxial with the head plate 62. The groove 64 is annular.

Each sliding unit 7 includes a slide 71 disposed slidably inside one of the track rails 3, and a pivot plate 72 connected to the slide 71 and disposed outwardly of the respective track rail 3. The pivot plate 72 has an end portion that is distal from the corresponding one of the track rails 3 and that is disposed around the pivot pin 63 between the extension plate 612 and the head plate 62 of the corresponding end piece unit 6. The pivot plate 72 defines a wide through hole 721 for passage of the head plate 62, a narrow through hole 722 connected to one side of the wide through hole 721 to receive the pivot pin 63, and a spring plate 73 formed in the wide through hole 721 and having a free end to abut against the head plate 62 when the pivot pin 63 is received in the narrow through hole 722.

Each slide 71 includes a slide rod 711 having a cylindrical shape and disposed within one of the track rails 3, and a connection plate 712 extending transversely from an outer periphery of the slide rod 711 and connected to the pivot plate 72.

The spring plate 73 further has a flat part 731 fixed to an edge confining the wide through hole 721, and a bending part 732 bending from the flat part 731 and having the free end extending outwardly of the wide through hole 721 to abut against a peripheral face of the head plate 62.

Moreover, each of the sliding units 7 further includes a driving rod 74 (see FIG. 3) disposed within the corresponding one of the track rails 3 and connected to the corresponding slide rod 711.

In use, when the two driving rods 74 are moved upward, the driving rods 74 push upward the respective two slides 71 and hence the two end piece units 6, retracting the two end piece units 6 into the cross bar 4 and moving the cross bar 4 toward the top edge of the rear window. As a result, the sunshade cloth 5 is expanded. Conversely, when the slides 71 are moved downward, the end piece units 6 project from the cross bar 4, and in the meantime, the winding shaft 2 rewinds the sunshade cloth 5, and the cross bar 4 moves downward toward the rear window shelf.

During assembly, the head plates 62 are pressed into the respective wide through holes 721 so that the bending parts 732 of the spring plates 73 are depressed and the pivot pins 63 are guided by the respective bending parts 732 to slide into the respective narrow through holes 722. After the free end of the bending part 732 of each spring plate 73 springs back, it abuts against the peripheral face of the head plate 62. Accordingly, each pivot plate 72 is positioned between one of the head plates 62 and one of the extension plates 612. Assembly of the end piece units 6 and the respective sliding units 7 are therefore quick and easy. For disassembly, the pivot pin 63 and the head plate 62 can be removed from the narrow through hole 722 and then from the wide through hole 721 by moving the bending part 732 of the spring plate 73 away from the head plate 62. Therefore, the end piece units 6 and the sliding units 7 can be separated easily from each other. In addition, because the connection between the end piece units 6 and the sliding units 7 is disposed externally of the track rails 3, the operation for assembly or disassembly can be conducted outside the track rails 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade device for a rear window of a vehicle, comprising:
a winding shaft;
two track rails;
a cross bar substantially parallel to said winding shaft;
a sunshade cloth having top and bottom ends respectively connected to said cross bar and said winding shaft;
two end piece units connected respectively to two opposite ends of said cross bar; and
two sliding units connected respectively to said end piece units and mounted slidably and respectively on said track rails;
each of said end piece units including an end piece inserted telescopically into one of said opposite ends of said cross bar, and a headed pivot projecting from said end piece and disposed outwardly of said cross bar, said headed pivot having a pivot pin, a head plate connected to said pivot pin, and a groove formed between said head plate and said end piece;
each of said sliding units including a slide disposed slidably inside one of said track rails, and a pivot plate connected to said slide, disposed outwardly of said one of said track rails, and disposed detachably around said pivot pin and between said head plate and said end piece, said pivot plate defining a wide through hole for passage of said head plate, a narrow through hole connected to one side of said wide through hole to receive said pivot pin, and a spring plate formed in said wide through hole and having a free end to abut against said head plate when said pivot pin is received in said narrow through hole.

2. The sunshade device of claim 1, wherein said spring plate further has a flat part fixed to an edge confining said wide through hole, and a bending part bending from said flat part and having said free end extending outwardly of said wide through hole to abut against said head plate.

3. The sunshade device of claim 1, wherein said end piece has an insert part inserted telescopically into one of said ends of said cross bar, and an extension plate projecting from an outer end of said insert part and having said pivot pin projected therefrom, said pivot plate being retained between said extension plate and said head plate.

4. The sunshade device of claim 3, wherein said outer end of said insert part has an end face transverse to said cross bar, said extension plate having a first part projecting transversely from said outer end of said insert part in proximity to said end face, and being flush with said end face, and a second part that is angled from said first part and that is parallel to and offset from said insert part, said pivot pin being perpendicular to said second part.

5. The sunshade device of claim 4, wherein said end piece further has a plurality of ribs, each of which projects from said end face and said first part and has an end fixed to one side of said second part oppositely of said pivot pin.

6. The sunshade device of claim 1, wherein said slide includes a slide rod disposed within one of said track rails, and a connection plate extending transversely from said slide rod and connected to said pivot plate.

7. The sunshade device of claim 6, wherein each of said sliding units further includes a driving rod disposed within one of said track rails and connected to said slide rod.
